(19) United States
(12) Patent Application Publication
(10) Pub. No.: US 2008/0245622 A1
(43) Pub. Date: Oct. 9, 2008

(54) Self-Boosting Friction Brake

(76) Inventors: Chi-Thuan Cao, Korntal-Muenchingen (DE); Dirk Hofmann, Stuttgart (DE); Herbert Vollert, Vaihingen/Enz (DE); Willi Nagel, Remseck/Hochdorf (DE); Bertram Foitzik, Ludwigsburg (DE); Bernd Goetzelmann, Sindelfingen (DE); Hans Frick, Wiggensbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/064,405

(22) PCT Filed: Jul. 21, 2006
(86) PCT No.: PCT/EP06/64515

§ 371 Date: Feb. 21, 2008

(30) Foreign Application Priority Data
Aug. 24, 2005 (DE) 102005039909.6
Dec. 1, 2005 (DE) 102005057300.2

(51) Int. Cl. F16D 55/48

(52) U.S. Cl. 188/72.2

(57) ABSTRACT

The invention relates to a self-boosting electromechanical friction brakes particularly in the form of a partially lined disk brake. The friction brake includes a friction brake lining which is helically movable with respect to the direction of rotation of a brake disk and pressed there into. A ramp mechanism is provided with ramps which cooperate with a roller bearing mechanism supporting the brake lining, to obtain the self-boosting effect. According to the invention, two of three rolls of the ramp mechanism are embodied with directing flanges for guiding the rolls on the ramps in order to helically guide the friction brake lining.

### PRIOR ART

The invention relates to a self-boosting friction brake having the characteristics of the preamble to claim 1. In particular, the friction brake is embodied as a disk brake, preferably in the form of a partially lined disk brake, although in principle other kinds of brakes, such as drum brakes, are equally possible. For the sake of simplicity, the invention will be described in terms of a partially lined disk brake, without thereby excluding other brake designs from the invention. The friction brake of the invention is intended for use in motor vehicles.

One such friction brake is known from International Patent Disclosure WO 03/056 204 A1. The know friction brake is embodied as a partially lined disk brake. It has a friction brake lining that for braking can be pressed by an electromechanical actuating device against a brake body that is to be braked. In the case of a disk brake, the brake body is a brake disk. The electromechanical actuating device of the known friction brake has an electric motor, a step-down gear, and a screw gear as a rotation-to-translation conversion gear. For braking, the friction brake lining is movable by the actuating device transversely or obliquely at an angle in the direction of rotation to the brake disk and thus can be pressed against the brake disk. The design of the electromechanical actuating device may deviate from what is shown. Although the friction brake of the invention is intended in particular for electromagnetic actuation, still other actuating devices are possible, such as hydraulic or pneumatic actuating devices.

For attaining self-boosting, the known friction brake has a ramp mechanism, with ramps extending at an angle to the brake disk, on which ramps the friction brake lining is braced as it presses against the brake disk. When in braking the friction brake lining is pressed against the rotating brake disk, the brake disk exerts a frictional force on the friction brake lining that urges the friction brake lining in the direction of an increasingly narrower, wedge-shaped gap between the ramps, which support the fiction brake lining, and the brake disk. Bracing the friction brake lining on the ramps of the ramp angle that extend obliquely to the brake disk brings about a force on the friction brake lining that has a force component transverse to the brake disk. This force component transverse to the brake disk is a compression force, which presses the friction brake lining against the brake disk. The compression force effected by the ramp mechanism increases a compression force exerted by the actuating device and thus increases the braking force of the friction brake. The increase in the compression and braking forces is called self-boosting.

The ramps and thus the direction of motion of the friction brake lining extend in the circumferential direction and obliquely at an angle to the brake disk; that is, they extend helically about an imaginary axis of rotation of the brake disk. The slope can vary over the course. For instance, by means of a steep slope at the beginning of motion of the friction brake lining, a gap (air gap) between the brake disk and the friction brake lining is quickly overcome, and by means of a shallow slope at the end of the motion of the friction brake lining, that is, with strong braking force, high self-boosting is attained. A special case or limit case of a ramp mechanism is a wedge mechanism, in which the angle at which the ramps extend to the brake disk is constant over the course of the ramps. In that case, the ramps are called wedges. The self-boosting is constant over the course of the ramps and over the displacement path of the friction brake lining.

The direction of motion of the friction brake lining need not necessarily be helical, or in other words have one component in the circumferential direction and one component transverse to the brake disk; for instance, the direction of motion may also have one component in the tangential direction to the brake disk. What is necessary for attaining the self-boosting is for the frictional force, exerted by the rotating brake disk on the friction brake lining pressed against it for braking, to urge the friction brake lining into the increasingly narrower gap between the ramps and the brake disk.

In the known friction brake, the ramp mechanism has a roller bearing of the friction brake lining with rollers that roll on the ramps. Rolling in the sense of the invention is understood to mean bodies of rotation that are symmetrical to an axis, such as wheels, disks, cylindrical or conical rollers, needles, and the like.

### EXPLANATION AND ADVANTAGES OF THE INVENTION

The fundamental concept of the invention is to guide the friction brake lining via the rollers of the ramp mechanism on the ramps in the intended direction of motion, or in other words in particular along a helical path about the axis of rotation of the brake disk. For that purpose, at least one roller of the ramp mechanism of the friction brake of the invention having the characteristics of claim 1 has a guide ring, which guides the roller on the ramp on which the roller is rolling. The guide ring may be embodied on the order of a wheel flange, of the kind known from railroad car wheels. The guide ring protrudes radially outward, in the manner of a radial flange, from a bearing face of the rollers. The guide ring may be embodied on one or both sides of the bearing face, or in the middle region thereof, in other words between the two edges of the bearing face of the roller. If the roller has a guide ring, then in one embodiment of the invention the guide ring is guided in a groove of the ramp or is located on one side of the ramp and guides the roller in only one axial direction of the roller. The guidance in the other axial direction is effected by a guide ring of another roller or in some other way. Another feature of the invention provides that the roller has two guide rings, which guide the roller on both sides of the ramp on which the roller is rolling. By this means as well, guidance in both axial directions of the roller is assured. The guidance of the friction brake lining in its intended direction of motion along the ramps of the ramp angle is an advantage of the invention.

The dependent claims have advantageous features and refinements of the invention defined by claim 1 as their subject.

The subject of claim 4 is a guidance of the friction brake lining with exactly two rollers, which are spaced apart from one another in the circumferential direction of the brake body and which are guided in both axial directions on the ramps on which they roll. To keep the transverse forces at the guide rings low, preferably two rollers, spaced as far apart from one another as possible in the circumferential direction of the brake body, are selected. This feature of the invention achieves a statically determined guidance of the friction brake lining.

For the sake of a statically determined bracing of the friction brake lining, claim S provides a roller bearing with exactly three rollers which are disposed at corners of an imaginary triangle. For the statically determined guidance, in this feature of the invention, besides the guide explained above with two rollers, which are guided in both axial directions on the ramps, it is also possible for there to be two or three rollers with guide rings on one side of the ramps on which they roll, while the third roller is guided with a guide ring on the other side of the ramp on which it rolls.

Claim 10 provides a roller mounting, which keeps the rollers positionally secure, so that they cannot be removed from their installed position by forces acting on them in an arbitrary direction. Since the rollers guide the friction brake lining, a transverse force can engage the rollers axially parallel and at a distance from the axes of rotation. This kind of transverse force exerts a tilting moment on the rollers. The roller mounting according to the invention prevents such a tilting moment, for instance, from being able to move the roller out of its intended position.

### DRAWINGS

The invention will be described below in terms of an exemplary embodiment shown in the drawings. Shown are:

FIG. 1, a perspective fragmentary view of a friction brake according to the invention;

FIG. 2, a back side of a bearer plate of a friction brake lining of the friction brake of FIG. 1, in perspective;

FIG. 3, a roller bearing of a roller of the friction brake of FIG. 1, in axial section;

FIG. 4, a modified roller, in a view corresponding to FIG. 3; and

FIG. 5, a back side of a bearer plate, modified compared to FIG. 2, of a friction brake lining of the friction brake of FIG. 1, in perspective.

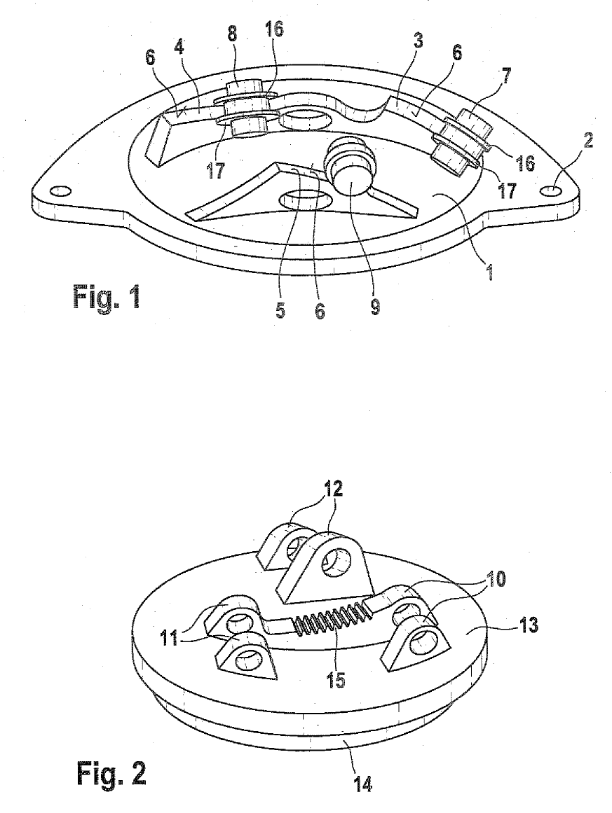

FIGS. 1, 2 and 5, in particular, are simplified for the sake of clear illustration.

### DESCRIPTION OF THE EXEMPLARY EMBODIMENT

The self-boosting friction brake of the invention is embodied as a partially lined disk brake with electromechanical actuation. It has a so-called frame caliper, of which a frame plate 1 is shown in FIG. 1. A second frame plate, not shown, is disposed parallel to the frame plate 1 shown; the two frame plates are joined together by tie rods, not shown, which are screwed to the frame plates 1 through holes 2. The brake disk, also not shown, is located between the two frame plates 1. A friction brake lining is disposed immovably on an inside, toward the frame plate 1 show, of the frame plate that is not shown. The design of brake calipers for disk brakes, including frame calipers, is familiar to one skilled in the art and therefore need not be explained in detail here.

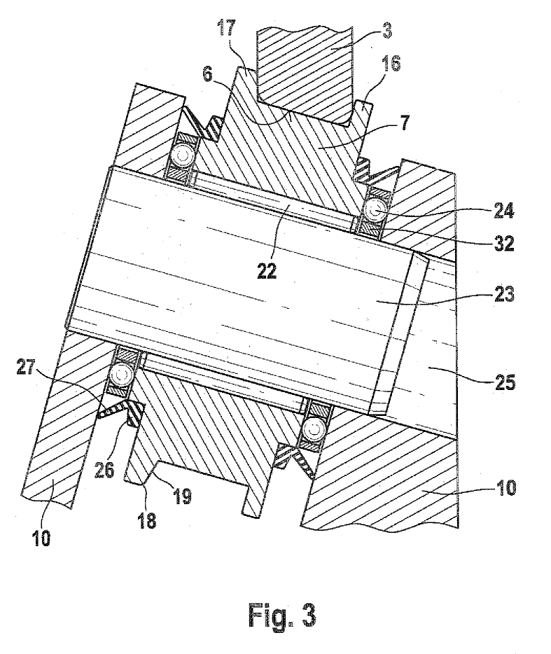

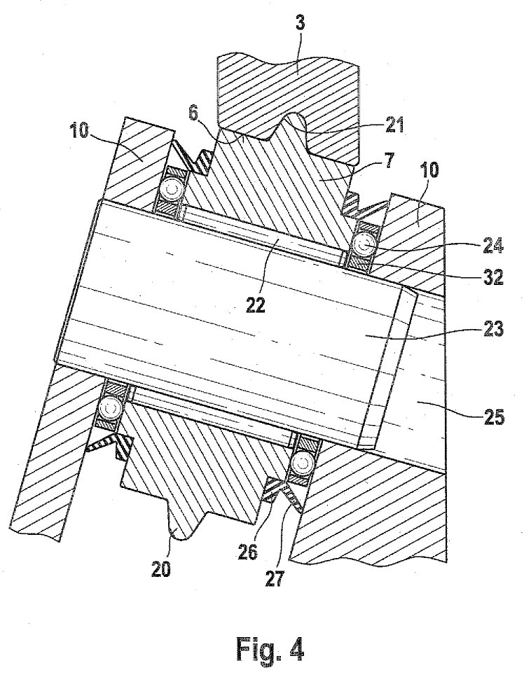

The frame plate 1 of the frame caliper of the partially lined disk brake of the invention, on its inside, pointing upward in FIG. 1, toward the brake disk that is not shown has three ramps 3, 4, 5, which are embodied as ribs protruding from the frame plate 1 in the direction of the brake disk that is not shown. The ramps 3, 4, 5 extend in an arc around an imaginary axis of rotation of the brake disk. Edges, oriented toward the brake disk not shown, of the ramps 3, 4, 5 form bearing faces, which in a circumferential direction of the brake disk that is not shown rise at a ramp angle; that is, the bearing faces 6 of the ramps 3, 4, 5 extend helically to the axis of rotation of the brake disk. Moreover, as can be better seen in FIGS. 3 and 4, the bearing faces 6 of the ramps 3, 4, 5 have a transverse inclination, and the transverse inclination of the bearing faces 6 of the radially outer ramps 3, 4 are oriented obliquely counter to a transverse inclination of a radially inner ramp 5.

Rollers 7, 8, 9 roll on the bearing faces 6 of the ramps 3, 4, 5. The rollers 7, 8, 9 are rotatably supported in pairs 10, 11, 12 of bearing blocks. The bearing block pairs 10, 11, 12 are located on a back side of a lining bearer plate 13, which is shown with its back side toward the top in FIG. 2. On its front side, located at the bottom in FIG. 2, the lining bearer plate 13 has a friction brake lining 14. In the assembled state, the front side of the lining bearer plate 13, which has the friction brake lining 14, faces toward the brake disk, not shown; the back side having the bearing block pairs 10, 11, 12 is oriented toward the inside, located at the top in FIG. 1, of the frame plate 1 of the brake caliper. Compared to the frame plate 1 shown in FIG. 1, the lining bearer plate 13 shown in FIG. 2 is inverted; that is, as noted, it is shown with its back side, the side facing the frame plate 1, at the top.

Via the rollers 7, 8, 9, the lining bearer plate 13 is braced on the ramps 3, 4, 5 of the frame plate 1. Because of the helical course of the bearing faces 6 of the ramps 3, 4, 5, the lining bearer plate 13 with the friction brake lining 14 is guided along a helical path about the axis of rotation of the brake disk not shown; the rollers 7, 8, 9 form a roller bearing for displacing the lining bearer plate 13. The three rollers 7, 8, 9 are disposed at corners of an imaginary triangle; as a result, the lining bearer plate 13 is braced at three points and in a statically determined fashion.

Two of the rollers 7, 8, spaced widely apart from one another in the circumferential direction, are disposed at the same radius from the axis of rotation of the brake disk not shown. The third roller 9 is disposed approximately in the middle in the circumferential direction between the two rollers 7, 8 and with a different radius from the axis of rotation of the brake disk. In the exemplary embodiment of the invention shown, the roller 9 disposed in the circumferential direction between the other two rollers 7, 8 has a shorter radius from the axis of rotation of the brake disk.

For being driven, the lining bearer plate 13 has a rack 15, which likewise extends helically about the axis of rotation of the brake disk not shown. The drive is effected electromechanically, with an actuating device, not show, that has an electric motor, a toothed gear as a step-down gear, and a gear wheel that meshes with the rack 15. Such actuating devices are familiar to one skilled in the art and therefore need not be explained in further detail here.

For actuating the disk brake, the lining bearer plate 13 with the friction brake lining 14 is displaced along the helically extending ramps 3, 4, 5, that is, is displaced helically to the axis of rotation of the brake disk not shown, by being driven at the rack 15 by the electromechanical actuating device, nor shown. As a result of the helical displacement, the lining bearer plate 13 moves in the circumferential direction and transversely to the brake disk not shown, so that the friction brake lining 14 comes to rest on the brake disk. The direction of displacement of the lining bearer plate 13 is equivalent to a direction of rotation of the brake disk. The brake disk is braked by friction between itself and the friction brake lining 14. The rotating brake disk exerts a frictional force on the friction brake lining 14, which urges the friction brake lining 14 and with the lining bearer plate 13 in the direction of the ascending ramps 3, 4, 5. The action on the lining bearer plate 13 is accordingly effected in the direction of an increasingly narrower interstice between the ramps 3, 4, 5 and the brake disk, not shown, that is parallel to the caliper plate 1. The increasingly narrower interstice between the ramps 3, 4, 5 and the brake disk can also be considered as an increasingly narrower wedge-shaped gap. The ramps 3, 4, 5 brace the lining bearer plate 13, and a bracing force has a force component transverse to the brake disk that presses the friction brake lining 14 against the brake disk. The ramps 3, 4, 5, which can also be called a ramp mechanism, in this way bring about an increase in the compression force of the friction brake lining 14 against the brake disk, and thus an increase in a braking force of the disk brake; the disk brake has self-boosting.

If the disk brake is intended to have self-boosting for both directions of rotation of the brake disk not shown, then the ramps 3, 4, 5 should be embodied as double ramps (not shown) with a slope in both circumferential directions. If the brake disk has a preferential direction of rotation, then as in the exemplary embodiment shown, the ramps 3, 4, 5 may have a slope in one circumferential direction, and as a result the self-boosting of the disk brake is effective only in the preferential direction of rotation of the brake disk.

For guidance of the lining bearer plate 13, two of the three rollers 7, 8 have guide rings 16, 17, as can be readily seen in the enlarged axial section in FIG. 3. The guide rings 16, 17 are embodied on the order of wheel flanges of railroad car wheels; they can also be conceived of as radial flanges. The guide rings 16, 17 fit laterally over the ramps 3, 4 on both sides and thereby guide the rollers 7, 8 and thus the lining bearer plate 13 on the ramps 3, 4. Since only two of the three rollers 7, 8 have guide rings 16, 17, the guidance is statically determined. To keep transverse forces of the guidance low, the two rollers 7, 8 that are spaced apart farthest from one another in the circumferential direction are embodied with guide rings 16, 17. The rollers 7, 8, 9 have the same transverse inclination as the bearing faces 6 of the ramps 3, 4, 5. For adaptation to the ramps 3, 4, which are positioned obliquely relative to the rollers 7, 8, an inner edge, extending all the way around, of one guide ring 17 is rounded (at reference numeral 18), and the inside flank 19 is adapted conically to a side face of the ramp 3, 4. The conical shape of the inside flank 19 and the rounding of the edge 18 extending all the way around is provided on the guide ring 17, on the side of which the bearing face 6 forms an obtuse angle with the side of the ramp 3, 4.

Statically determined guidance of the lining bearer plate 13 is also possible (not shown) with only one guide ring on each of the three rollers 7, 8, 9. In that case, the guide rings are either each disposed on the insides, facing one another, of the ramps 3, 4, 5, or are disposed on the outsides, facing away from one another, of the ramps 3, 4, 5.

A further guidance option is shown in FIG. 4. In it, the guide ring 20 is provided in the middle of the rollers 7, 8 that are spaced apart farthest from one another in the circumferential direction, and it engages a groove 21 in the bearing face 6 of the ribs 3, 4.

The rollers 7, 8, 9, as shown in FIGS. 3 and 4, are radially supported by a needle bearing 22 on a bolt 23 and are axially supported by ball bearings 24. The ball bearings 24 are disposed between face ends of the rollers 7, 8, 9 and inside faces, facing toward one another, of the bearing block pairs 10, 11, 12. The bolt 23 is press-fitted into aligned bores 25 in the bearing block pairs 10, 11, 12. Sealing rings 26, which are mounted on a collar of the rollers 7, 8, 9 and whose sealing lips 27 rest on the insides facing toward one another of the bearing block pairs 10, 11, 12, hermetically seal the bearings 22, 24.

The needle bearing 22 forms a radial bearing; the ball bearings 24 form axial bearings. The bearings 22, 24 are bearing-ringless; that is, they have no inner race or outer race, and the axial bearings 24 have no bearing rings located side by side between which the roller bodies roll. The needles of the needle bearing 22 roll directly on the bolt 23 that forms the shaft of the rollers 7, 8, 9 and directly in an axial hole in the rollers 7, 8, 9. The balls of the ball bearings 24 roll directly on end faces of the rollers 7, 8, 9 and on inside faces, toward them, of the bearing block pairs 10, 11, 12. The rotary bearings of the rollers 7, 8, 9 are low in friction, have fewer parts than bearings with bearing rings, and are moreover less expensive, since they are parts that are easier to produce. In FIGS. 3 and 4, ball cages are identified by reference numeral 32; they keep the balls of the ball bearings 24 at their spacing from one another. There are no bearing rings on which the balls roll.

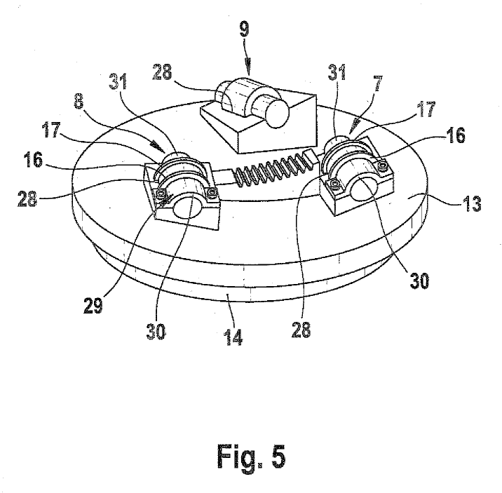

For the explanation of the lining bearer plate 13, show in FIG. 5 and modified compared to FIG. 2, the same reference numerals are used for components that match those of FIGS. 1 and 2. Instead of the lining bearer plate 13 shown in FIG. 2, the lining bearer plate 13 shown in FIG. 5 cooperates, in the manner explained above, with the frame plate 1, shown in FIG. 1, of the frame caliper of the partially lined disk brake of the invention.

In FIG. 5, the rollers 7, 8, 9 shown in FIG. 1 are shown once again. They rest rotatably in semicylindrical pockets 28 of graduated diameter, which are mounted in the back side, remote from the friction brake lining 14, of the lining bearer plate 13. The roller 9, which has no guide ring, rests loosely in its pocket 28; in the assembled frame caliper, it is held in the pocket 28 by the ramp 5 on which it rolls. The other two rollers 7, 8, which have the guide rings 16, 17, are secured, or in other words kept in their pockets 28, by roller mountings 29. The roller mountings 29 have shackles 30, which fit over shafts 31 of the rollers 7, 8. The shackles 30 are screwed to the lining bearer plate 13. The shackles 30 that form the roller mountings 29 keep the rollers 7, 8 in the pockets 28 and consequently keep them positionally securely in or on the lining bearer plate 13. In the exemplary embodiment shown, the shackles 29 are each provided on only one side of the rollers 7, 8. In principle, such shackles 30 may also be provided on both sides of the rollers 7, 8.

Since the guide rings 16, 17 guide the rollers 7, 8 laterally on the ramps 3, 4 of the frame plate 1, transverse forces can engage the guide rings 16, 17 of the rollers 7, 8 axially parallel to the rollers 7, 8 and at an axial spacing corresponding to the radius of the guide rings 16, 17. These transverse forces exert a tilting moment on the rollers 7, 8. The roller mountings 29 with the shackles 30 prevent such a tilting moment from moving the rollers 7, 8 out of the pockets 28.

The rollers 7, 8, 9 may, as shown in FIGS. 3 and 4, be rotatably supported on the shafts 31. The shafts 31 in that case are formed by the bolts 23 shown in FIGS. 3 and 4. In principle, the shafts 31 may also be rotatably slide- or roller-supported (not shown) in the pockets 28 and the shackles 30.

1-13. (canceled)

14. A self-boosting friction brake, comprising:
a friction brake lining that is movable in a direction of rotation of a brake body and into contact with the brake body;
an actuating device which moves the friction brake lining against the brake body for braking;
a ramp mechanism that guides the friction brake lining at a ramp angle to the brake body, the ramp mechanism including ramps that extend from a frame plate to the brake body at the ramp angle; and
a roller bearing mechanism movably supporting the friction brake lining at the ramp angle to the brake body, the roller bearing mechanism having rollers that roll on the ramps of the ramp mechanism, wherein at least one roller of the ramp mechanism has a flange, which guides the roller on the ramp on which the roller rolls.

15. The self-boosting friction brake according to claim 14, wherein at least one roller has flanges that guide the roller on both sides of the ramp on which the roller rolls.

16. The self-boosting friction brake according to claim 14, wherein the flange of the roller is guided in a groove of the ramp.

17. The self-boosting friction brake according to claim 14, wherein precisely two rollers of the roller bearing mechanism spaced apart in the circumferential direction of the brake body have a flange guide on the ramps, on which they roll, in both axial directions of the two rollers.

18. The self-boosting friction brake according to claim 14, wherein two rollers of the roller bearing mechanism have a flange guide on the ramps, on which they roll, in opposed axial directions of the two rollers.

19. The self-boosting friction brake according to claim 14, wherein the rollers of the roller bearing mechanism are roller-supported.

20. The self-boosting friction brake according to claim 14, wherein each roller has a sealed roller bearing.

21. The self-boosting friction brake according to claim 14, wherein the roller bearing mechanism has exactly three rollers, which are located at the corners of an imaginary triangle.

22. The self-boosting friction brake according to claim 14, wherein the friction brake is embodied as an electromechanical partially lined disk brake.

23. The self-boosting friction brake according to claim 14, wherein friction brake has a roller mounting, which holds the rollers positionally securely.

24. The self-boosting friction brake according to claim 23, wherein the roller mounting has a shackle, which fits over a shaft of the rollers and keeps it in a shaft receptacle.

25. The self-boosting friction brake according to claim 1, wherein the rollers have an axial and/or a radial roller bearing.

26. The self-boosting friction brake according to claim 25, wherein the roller bearing is bearing-ringless.
